(19) United States
(12) Patent Application Publication
(10) Pub. No.: US 2013/0119662 A1
(43) Pub. Date: May 16, 2013

(54) WIND TURBINE CONTROL

(71) Applicant: Andrew Carlton Thacker, II, Lakewood, CO (US)

(72) Inventor: Andrew Carlton Thacker, II, Lakewood, CO (US)

(21) Appl. No.: 13/635,615

(22) PCT Filed: Mar. 11, 2011
(86) PCT No.: PCT/US11/28158

§ 371 Date: Feb. 4, 2013

Related U.S. Application Data
(63) Continuation-in-part of application No. 13/039,954, filed on Mar. 3, 2011, now abandoned.
(60) Provisional application No. 61/314,104, filed on Mar. 15, 2010.

(51) Int. Cl. F03D 7/06

(52) U.S. Cl. CPC F03D 7/06
USPC 290/44

(57) ABSTRACT

Wind turbine systems and methods are provided. The wind turbine system includes a plurality of coaxial, counter-rotating turbine assemblies. First and second shroud assemblies define a generally spherical volume containing the first and second turbine assemblies. The first and second shroud assemblies each include a shroud member that is controlled in response to information from a wind sensor to selectively shield or expose portions of the respective turbine assemblies to the wind by changing the rotational position of the shroud members about the system axis. The turbine assemblies are interconnected to a generator for the production of electrical power.

### FIELD

The present invention is directed to wind turbine systems and methods. More particularly, the present invention relates to the instrumentation and control of wind turbine systems.

### BACKGROUND

Several decades of development have focused on harnessing the power of the wind to turn water and grist mills, and since the invention by Westinghouse in the late 1800's, to produce electrical power. Many types of designs have been proffered, however, they have been focused almost entirely on horizontal turbines with blades, sails or propellers to convert the kinetic energy of wind into a force to drive various types of electrical generators, including alternating current (AC), direct current (DC) and 3-phase current for storing and using power as the demand presents itself or to provide power directly into the public and private utility grids for distribution from substations to homes, offices, hotels, casinos, cities and municipalities, industrial and other energy dependent user applications.

The past 20 years has seen a much greater emphasis on renewable energy sources as alternatives to fossil fuel power plants burning coal, natural gas, fuel oil or nuclear fuels to produce steam to power large scale electrical generators to reduce the impact of carbon compounds upon the Earth's atmosphere. These efforts have primarily been directed to large scale utility grids and the emphasis has been on large scale production systems (wind farms) greater than 1 megawatt that are geographically concentrated in remote locations where wind is available. It is now common to see systems greater than 4 megawatts in one tower. The systems developed can cost multi-million dollars each. The systems can be highly complex, enormous in size and scale and number in the tens of thousands in North America and world-wide. Towers of 200-400 feet in height are common on prairies and savannas, along our coastal regions, and even off-shore in shallow ocean waters. It was thought that these systems would have an enormous impact in offsetting the use of carbon based fuels and provide a cheap source of unlimited power.

Unfortunately, this has not been the case and large utilities are now rethinking their use of these systems due to several inherent problems with the design and deployment of the systems. Among the problems impacting these systems are variations in wind speeds over the sweep of the propellers (60 ft-450 ft), ground turbulence that causes prop dithering and imbalance, and gusting winds that apply uneven forces and torqueing of the drive axles which have resulted in expensive and time consuming repairs of system mechanical drive trains and transmissions which cannot respond quickly to these changing dynamic loads. Other problems include overheating of the turbines resulting in transmission system and hydraulic system fires, wind loads that have caused complete system failure and total collapse of the towers, flickering light patterns disturbing cattle and other livestock, and complaints from people living near the turbines with regard to noise, bird kills, and flickering light patterns in their home windows. Recently complaints have been lodged by the Federal Aviation Administration and the United States AeroSpace Command regarding interference with air traffic control radar and guidance systems both on the ground and airborne caused by large scale wind farms.

Additionally, significant losses in electrical energy are incurred due to long distance transmission from the wind farm sites to the utility substations which has resulted in low utilization of wind power and has reduced the effectiveness and reliability of the power generated. System shut down in gusty and turbulent wind conditions has resulted in “spiking” in the utility grid, creating inefficiency. The system loads can be unpredictable and unreliable. In many cases, wind energy is not used due to these problems and the utility industry is rethinking its investment and deployment strategy.

On a smaller scale, wind turbine systems have been developed for generating power at or near the point of use. However, such systems have typically had only modest power generation capabilities, thereby limiting their application to the useful generation of power. For example, such systems have been utilized for low power applications, such as charging batteries and direct current (DC) applications. As a result, deployment of such systems has typically been limited to remote locations, where electrical power may otherwise be unavailable, as opposed to being deployed as an alternate energy source where grid power is otherwise available. Therefore, the use of wind generated electrical power at or near the point of use, on a scale at which the sale of electricity to an electric utility during times when the wind generated power is not entirely consumed at the location, has been limited.

### SUMMARY

The present invention is directed to solving these and other problems and disadvantages of the prior art. In accordance with embodiments of the present invention, a wind turbine system having first and second turbine assemblies is provided. The first and second turbine assemblies are configured to rotate about a first axis, in opposite directions, in the presence of a suitable wind. In addition, first and second shroud assemblies are associated with the first and second wind turbine assemblies respectively. The first and second shroud assemblies extend around the outer circumference of the corresponding first and second turbine assemblies. In addition, the shroud assemblies include shroud members that extend around some portion of the outer circumference of the respective turbine assembly.

In accordance with further embodiments of the present invention, the first and second shroud assemblies are associated with shroud assembly motors that control the rotational position of the shrouds. Moreover, the shroud assembly motors are operated at the direction of a shroud control system. The shroud control system determines the orientation in which the shrouds are to be placed based on various parameters. These parameters include the selected operating mode of the wind turbine system, the wind direction, and the wind speed.

A wind turbine system in accordance with embodiments of the present invention can include various sensors or instruments that provide information to the shroud control system. These instruments can include an anemometer capable of providing wind speed information, and a wind vane capable of providing wind direction information. A combined wind speed and direction instrument can also be used. As another example, a tachometer can be provided to provide information regarding the revolutions per minute (RPM) of the drive shafts and/or generator input shaft. As still other examples, sensors monitoring the output of the generator, generator temperature, ambient barometric pressure, or other parameters can be included.

Methods in accordance with embodiments of the present invention include controlling the shrouds associated with the counter-rotating turbine assemblies to selectively expose the turbine assemblies to or shield the turbine assemblies from the wind. More particularly, in a power generation mode the shroud assemblies are rotated about a first axis of the system to expose a portion of a corresponding wind turbine assembly to the wind, while shielding another portion of that wind turbine assembly from the wind. Moreover, the extent of the turbine assemblies that are exposed to the wind can be modified, based on the velocity of the wind. The shroud assemblies can thus be used to control the exposure of the turbine assemblies to the wind so that the turbine assemblies are driven in a desired direction and to control the force of the wind on the turbine assemblies. In addition, in an idle mode, the shroud assemblies can be positioned to entirely or substantially shield the turbine assemblies, for example where the generation of power is not desired, or to protect the wind turbine system from extremely strong winds.

Additional features and advantages of embodiments of the present invention will become more readily apparent from the following description, particularly when taken together with the accompanying drawings.

### BRIEF DESCRIPTION OF THE DRAWINGS

FIG. 1 depicts a wind turbine system in accordance with embodiments of the present invention in an exemplary operating environment;

FIG. 2A is a block diagram depicting components of a wind turbine system in accordance with embodiments of the present invention;

FIG. 2B is a block diagram depicting control and instrumentation components of a wind turbine system in accordance with embodiments of the present invention;

FIG. 3 is a front view in elevation of a wind turbine system in accordance with embodiments of the present invention;

FIG. 4 is a perspective view of a wind turbine system in accordance with embodiments of the present invention;

FIG. 5 is a perspective view of wind turbine system support structure components in accordance with embodiments of the present invention;

FIG. 6A is a top perspective view of a first turbine assembly in accordance with embodiments of the present invention;

FIG. 6B is a top plan view of a first turbine assembly in accordance with embodiments of the present invention;

FIG. 6C is a view in elevation of a first turbine assembly in accordance with embodiments of the present invention;

FIG. 7A is a top perspective view of a second turbine assembly in accordance with embodiments of the present invention;

FIG. 7B is a top plan view of a second turbine assembly in accordance with embodiments of the present invention;

FIG. 7C is a view in elevation of a second turbine assembly in accordance with embodiments of the present invention;

FIG. 8A is a front perspective view of a turbine assembly blade in accordance with embodiments of the present invention;

FIG. 8B is a side elevation of a turbine assembly blade in accordance with embodiments of the present invention;

FIG. 8C is a first end view of a turbine assembly blade in accordance with embodiments of the present invention;

FIG. 8D is a second end view of a turbine assembly blade in accordance with embodiments of the present invention;

FIG. 9 is a flowchart depicting aspects of the operation of a wind turbine system in a power generation mode in accordance with embodiments of the present invention;

FIG. 10 is a flowchart depicting aspects of the operation of a wind turbine system in an idle mode in accordance with embodiments of the present invention;

FIG. 11A depicts a wind turbine system in accordance with embodiments of the present invention, and illustrates shroud member positions in an exemplary operating environment;

FIG. 11B depicts the shroud member positions of FIG. 11A in plan view;

FIG. 12A depicts a wind turbine system in accordance with embodiments of the present invention, and illustrates shroud member positions in another operating environment;

FIG. 12B depicts the shroud member positions of FIG. 12A in plan view;

FIG. 13A depicts a wind turbine system in accordance with embodiments of the present invention, and illustrates shroud member positions in another operating environment;

FIG. 13B depicts the shroud member positions of FIG. 13A in plan view;

FIG. 14A depicts a wind turbine system in accordance with embodiments of the present invention, and illustrates shroud member positions in another operating environment;

FIG. 14B depicts the shroud member positions of FIG. 14A in plan view;

FIG. 15A depicts a wind turbine system in accordance with embodiments of the present invention, and illustrates shroud member positions in another operating environment;

FIG. 15B depicts the shroud member positions of FIG. 15A in plan view;

FIG. 16A depicts a wind turbine system in accordance with embodiments of the present invention, and illustrates shroud member positions in another operating environment;

FIG. 16B depicts the shroud member positions of FIG. 16A in plan view;

FIG. 17 is a cross-section of a portion of an equatorial bearing assembly in accordance with embodiments of the present invention; and

FIG. 18 is a cross-section of another portion of an equatorial bearing assembly in accordance with embodiments of the present invention.

### DETAILED DESCRIPTION

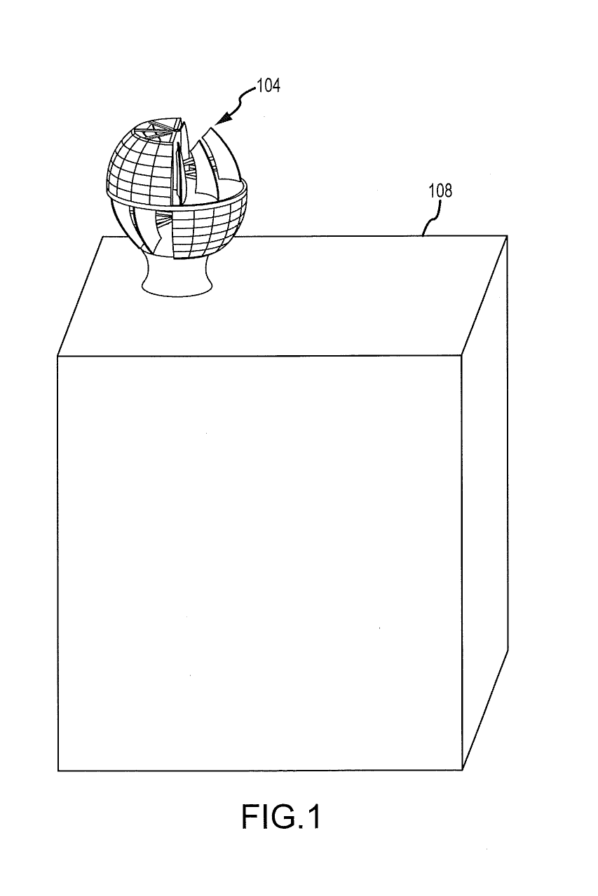

FIG. 1 depicts a wind turbine system 104 in accordance with embodiments of the present invention, in an exemplary operating environment. In particular, the wind turbine system 104 is shown mounted to a platform 108. In this example, the platform 108 comprises a tall building, and the wind turbine system 104 is mounted to the roof of that building 108. However, a wind turbine system 104 in accordance with embodiments of the present invention can be associated with any type of platform 108. Therefore, examples of suitable platforms 108 to which a wind turbine system 104 as disclosed herein can be mounted include, in addition to tall buildings such as skyscrapers, mid-rise buildings, warehouses, big box retail stores, residences, towers, storage tanks, bridges or platforms. In addition, although depicted in an upright vertical orientation in the example of FIG. 1, a wind turbine system 104 can be mounted in alternate orientations. For example, a wind turbine system 104 can be mounted in a horizontal orientation, for instance to the side of a platform 108 comprising a building or tower. As another example, a wind turbine system 104 in accordance with embodiments of the present invention can be mounted in an upside down vertical orientation, for example to the underside of a bridge.

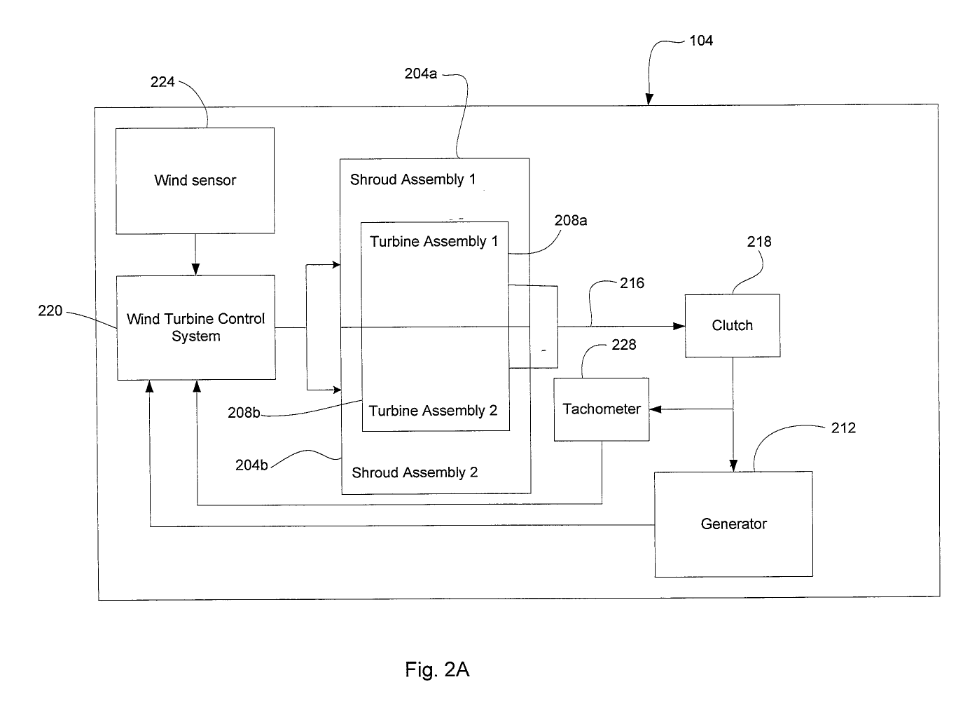

FIG. 2A is a block diagram depicting components of a wind turbine system 104 in accordance with embodiments of the present invention. In general, the wind turbine system 104 can include a number of shroud assemblies 204. For instance, a wind turbine system 104 can include a first shroud assembly 204a and a second shroud assembly 204b. In general, each shroud assembly 204 is associated with and can at least partially define a volume containing a turbine assembly 208. Accordingly, a wind turbine system 104 can include a first turbine assembly 208a and a second turbine assembly 208b. The turbine assemblies 208 can be coupled to an electrical generator 212 by a drive train assembly 216. Although referred to herein as a generator 212, the component of the wind turbine system 104 used to generate electricity may comprise a motor operated as an electrical generator. As an example, and without limitation, the generator 212 may comprise a 60 Hz 3 phase permanent magnet generator. In accordance with embodiments of the present invention, the generator 212 can comprise any electrical generator. Moreover, the drive train assembly 216 can include drive shafts that interconnect the turbine assemblies 208 to an input shaft of the generator 212 via a clutch 218. The clutch 218 can, for example, comprise a centrifugal clutch. The wind turbine system 104 can also include a wind turbine control system 220. The wind turbine control system 220 can comprise motors, sensors, and controllers or processors for determining and controlling the position of the shroud assemblies 204. In addition, the wind turbine system 104 can include various instruments or sensors that provide input to the wind turbine control system 220. For example, a wind sensor 224 can be provided to supply wind speed and direction information to the wind turbine control system 220. The wind sensor 224 can comprise separate anemometer and wind vane instruments. In accordance with further embodiments, the wind sensor 224 can comprise an integrated sensor. An example of an integrated sensor is the Vaisala WINDCAP™ ultrasonic wind sensor model WMT700. The wind turbine system 104 can also include a tachometer 228 to provide information regarding the rate in revolutions per minute that the wind turbine assembly's 208 generator 212 and associated drive train components 218 are spinning.

FIG. 2B illustrates various control and instrumentation components that can be included in a wind turbine system 104. In particular, details of a wind turbine control system 220 and associated instruments and interconnected nodes in accordance with embodiments of the present invention are illustrated. As shown, the wind turbine control system 220 can include a processor 232 capable of executing program instructions or software. Accordingly, the processor 232 may include any general purpose programmable processor or controller for executing application programming or instructions. As a further example, the processor 232 may comprise a specially configured application specific integrated circuit (ASIC). The processor 232 generally functions to run programming code or instructions implementing various control and communication features of the wind turbine system 104.

The wind turbine control system 220 may additionally include memory 236 for use in connection with the execution of programming by the processor 232, and for the temporary or long term storage of program instructions and/or data. As an example, the memory 236 may comprise RAM, SDRAM, or other solid state memory. Alternatively or in addition, data storage 240 may be provided. In accordance with embodiments of the present invention, data storage 240 can contain program code or instructions implementing various of the applications or functions executed or performed by the wind turbine control system 220, and data that is used and/or generated in connection with the execution of applications and/or of the performance of functions, including the generation of electrical power by the wind turbine system 104. Like the memory 236, the data storage 240 may comprise a solid state memory device. Alternatively or in addition, the data storage 240 may comprise a hard disk drive or other random access memory.

Examples of application programming or instructions that can be stored in data storage 240 for execution by the processor 232 include one or more control algorithms 244 for receiving input from the wind sensor 224, tachometer 228, and/or other instruments or control inputs, and for controlling the operation of shroud control motors 248 associated with the shroud assemblies 204. Other examples of application programming or instructions that can be stored in data storage 240 include various communication applications 252. The communication applications 252 can send and receive control information with respect to the control algorithms 244. Moreover, communication applications 252 can provide a user interface for an administrator or operator. As yet another example, a data logging application 256 can be included. The data logging application 256 can operate to organize and store data 260, for example data received via control algorithms 244 regarding the performance of the wind turbine system 104, for later analysis and/or retrieval.

A wind turbine control system 220 can also include one or more user input devices 264. Examples of user input devices 264 include a touch screen display, keyboard, pointing device combined with a display screen or other position encoder, microphone or other audible input device, keypad, or switches. In addition, a wind turbine control system 220 can include or be associated with one or more user output devices 268. Examples of user output devices 268 include a display, an audio output device, and indicator lamps. User input 264 and output 268 devices can be directly connected to and included as part of the wind turbine control system 220, and/or can be provided by interconnected devices. A wind turbine control system 220 also generally includes one or more communications interfaces 272. A communications interface 272 generally functions to interconnect the wind turbine control system 220 to associated components or control nodes. Accordingly, communications interfaces 272 can provide direct or networked connections to wind turbine system 104 components, such as the wind sensor 224, tachometer 228, and/or shroud control motors 248. A communications interface 272 can also provide an interconnection to a communications network 276, which can in turn support connectivity between the wind turbine system 104 and a remote administration/control node 280 or other systems and devices 284. Examples of a remote administration/control node 280 is a device operated by a system administrator to control operating parameters of the wind turbine system 104, and/or the interoperability of the wind turbine system 104 and the power distribution grid. Examples of other systems and devices 284 include mobile applications that can be used to provide operating personnel with information concerning the operation of the wind turbine system 104. Examples of a communications interface 272 in accordance with embodiments of the present invention include universal serial bus (USB), IEEE 1394, wired or wireless Ethernet, Wi-Fi, cellular telephony, public switched telephony network, satellite, or other direct connections, busses, or network systems.

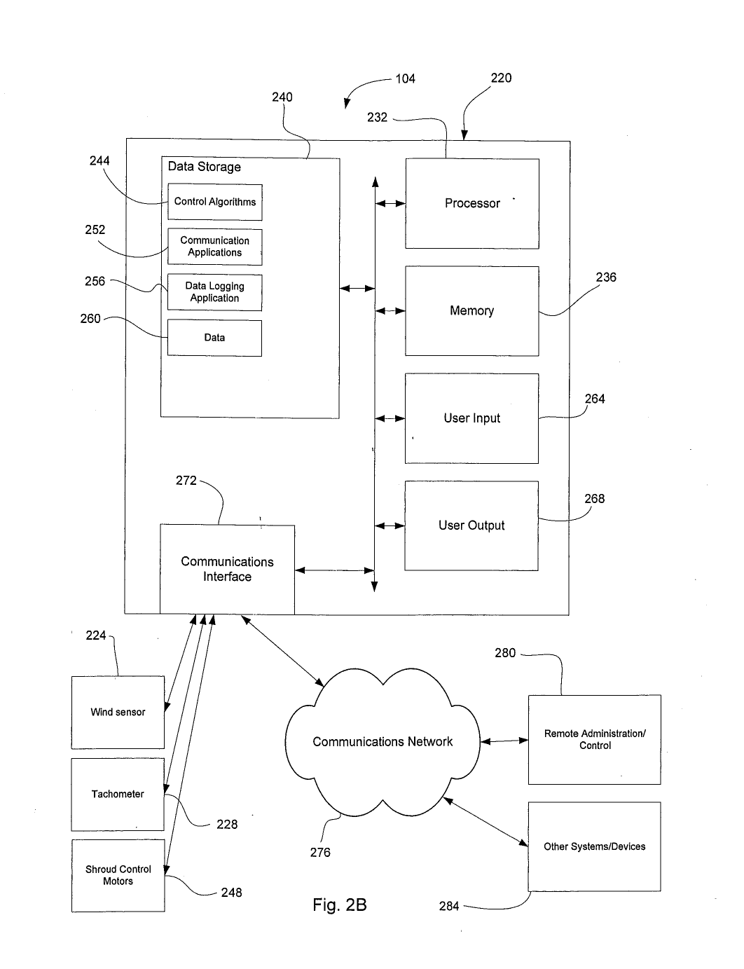

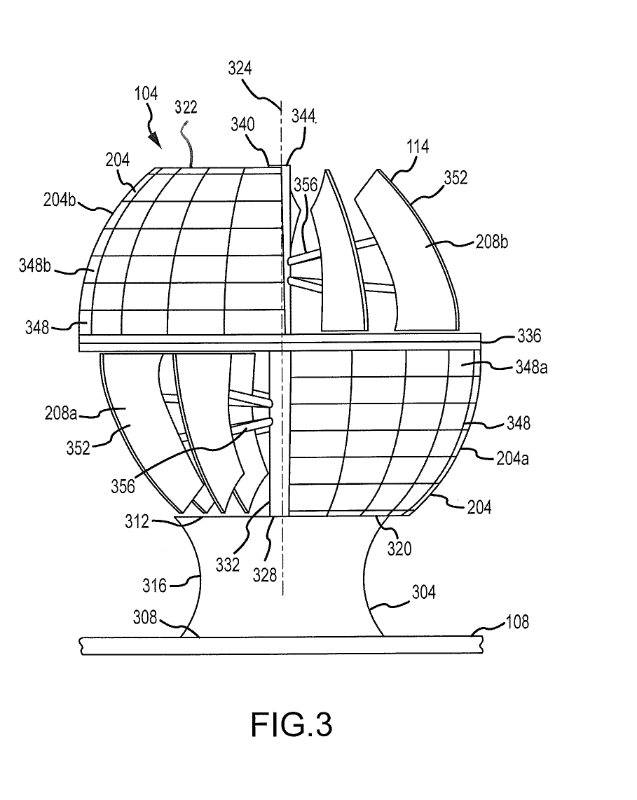

FIG. 3 depicts a wind turbine system 104 in accordance with embodiments of the present invention in elevation. In this exemplary embodiment, the wind turbine system 104 is mounted to a base member 304 that is in turn mounted to the platform 108. In this embodiment, the base member 304 includes a bottom plate or first end surface 308 and a top plate or second end surface 312. Although the terms top and bottom are used throughout the specification for ease of description, it should be appreciated that the wind turbine system 104 can be oriented such that the bottom surface is above the top surface, or is at the same elevation or average elevation above the ground as the top surface, depending on the orientation of the wind turbine system 104. Accordingly, as used herein, a bottom surface, member or other element refers to an instance of the associated component or assembly that is more proximal to the platform 108 or the base member 304 than is a top component or assembly. The bottom plate or first end surface 308 can comprise a first circular end surface, while the top plate or second end surface 312 can comprise a second circular end surface. In this particular embodiment, the base member 304 includes an intermediate section 316 having a diameter that is less than the diameter of the first circular end surface 308 and the second circular end surface 316. Accordingly, the base member 304 can have a profile that is tapered in the center.

The first shroud assembly 204a is mounted to the base member 304 via a first circular track or peripheral bearing assembly 320. The peripheral bearing assembly 320 allows the first shroud assembly 204a to be rotated relative to the base member 304 about a first or system axis 324. A first central bearing assembly 328 can also be provided to rotatably interconnect the first shroud assembly 204a to the base member 304 and/or a first drive shaft 332. The second shroud assembly 204b is interconnected to the first shroud assembly 204a via a second circular track or equatorial bearing assembly 336. The equatorial bearing assembly 336 allows the second shroud assembly 204b to be rotated about the system axis 324 relative to the base member 304, and relative to an independently of the first shroud assembly 204a. A second central bearing assembly 340 can also be provided to rotatably interconnect the second shroud assembly 204b to a second drive shaft 344. Sensors comprising position encoders can be associated with or incorporated into some or all of the bearing assemblies 320, 328, 336 and 340, to provide information to a controller of the shroud control system 220 regarding the positions of the shroud assemblies 304 about the system axis 324.

Each of the shroud assemblies 204 includes a shroud member 348. In particular, a first shroud member 348a associated with the first shroud assembly 204a generally extends between the peripheral bearing assembly 320 and the equatorial bearing assembly 336. In addition, the first shroud member 348a is generally hemispherical in that it extends for about one half the outer circumference of the first shroud assembly 204a. The second shroud assembly 348b generally extends between the equatorial bearing assembly 336 to or near a top extent of the wind turbine system 104, and is generally hemispherical in that it extends around about one half the outer circumference of the second shroud assembly 204b. In addition, the shroud assemblies 204 together define a shape that is generally spherical.

The shroud assemblies 204 also generally describe a partially enclosed volume comprising a housing for the turbine assemblies 208. In particular, the first shroud assembly 204a partially encloses the first turbine assembly 208a. Similarly, the second shroud assembly 204b partially encloses the second turbine assembly 208b. The rotational locations about the system axis 324 that are enclosed by the shroud members 348 of the shroud assemblies 204 is controlled to provide a desired operational state of the wind turbine system 104, as described elsewhere herein. Moreover, positioning of the shroud assemblies 204 and/or shroud members 348 can be effected through the actuation of motors 248, such as stepper motors, associated with or incorporated into the shroud assemblies 204, the shroud members 348, and/or some or all of the bearings 320, 322, 328, 336, and 340. In accordance with further embodiments of the present invention, the shroud members 348 can be rotated about the system axis 324 by moving the shroud members 348 along tracks at the equatorial bearing assembly 336 and, with respect to the first shroud member 348a, the first circular track or bearing assembly 320 and, with respect to the second shroud member 348b a second peripheral bearing assembly 322. Accordingly, in at least some embodiments, the shroud members 348 can be rotated about the system axis 324 along bearings, while the remainder of the associated shroud assemblies 204 and at least some components of the bearing assemblies can comprise support members that remain stationary with respect to the system axis 324.

In addition, embodiments of the present invention include turbine assemblies 208 that each comprise a plurality of airfoils or blades 352 having a first surface 804 and a second surface 808. Moreover, the blades 352 of the first turbine assembly 208a are oriented to rotate that assembly 208a in a first direction about the system axis 324, while the blades 352 of the second turbine assembly 208b are oriented to rotate that assembly 208b in a second direction about the system axis 324. In accordance with embodiments of the present invention, the first turbine assembly 208a may have a first number of blades 352, and the second turbine assembly 208b may have a second, different number of blades 352. Accordingly, the turbine assemblies 208 are asynchronous in operation. Each of the blades 352 of the first turbine assembly 208a can be interconnected to the first drive shaft 332 by a blade support structure 356. Similarly, each of the blades 352 of the second turbine assembly 208b can be interconnected to the second drive shaft 344 by a blade support structure 356. The blade support structure 356 can include one or more struts, although other configurations are possible.

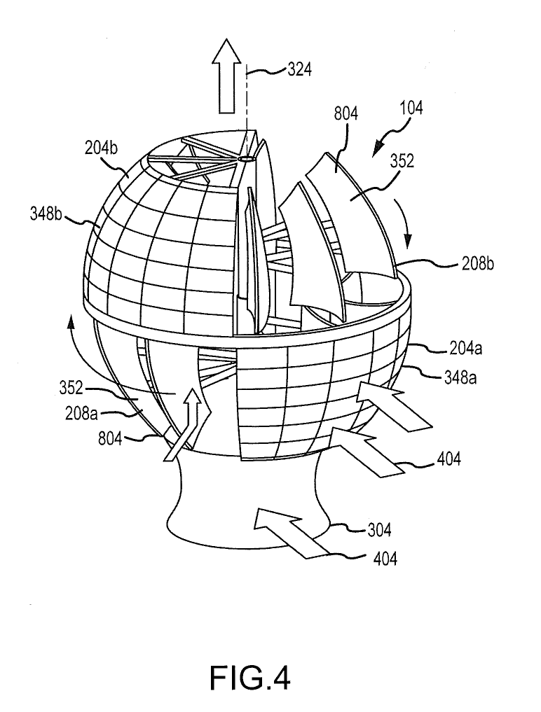

FIG. 4 is a perspective view of a wind turbine system 104 in accordance with embodiments of the present invention. More particularly, FIG. 4 illustrates the relationship of a wind turbine system 104 to a prevailing wind 404 and flow paths through the wind turbine system 104 under exemplary operating conditions. In FIG. 4, the shroud assemblies 204 are shown positioned such that about a 90° section or arc of each of the turbine assemblies 208 is exposed to face the wind 404. Moreover, the shroud assemblies 204 are positioned so that the wind is incident on the first side or surface 804 of the blades 352 of the turbine assemblies 208, and to allow the wind 404 to apply a generally tangential force on the turbine assemblies 208 such that the turbine assemblies 208 rotate in opposite directions about the system axis 324. Thus, in this example, the resulting exposure of the turbine assemblies 208 to the incident wind 404 causes the first turbine assembly 208b to be rotated in a clockwise direction about the system axis 324, and causes the second turbine assembly 208b to be rotated in a counter-clockwise direction, when the wind turbine system 104 is viewed from above. In addition, the wind turbine system 104 provides a stepper or dual compressor effect with respect to at least some of the incident wind 404. In particular, the blades 352 of the first turbine assembly 208a generally direct at least some of the wind incident thereon upwards through the wind turbine system 104, to the second turbine assembly 204b. Therefore, in addition to the wind 404 that is directly incident on the blades 352 of the second turbine assembly 208b, at least some wind that was incident on the blades 352 of the first turbine assembly 204a is available to also act on the blades 352 of the second turbine assembly 208b.

As can be appreciated by one of skill in the art after consideration of the present disclosure, the counter-rotation of the first 208a and second 208b turbine assemblies results in a small or even zero torsional force on an associated platform 108. In addition, the counter-rotating turbine assemblies 208 can provide reduced vibration characteristics as compared to systems that do not employ counter rotating turbine assemblies or elements that are asynchronous due to having differing numbers of blades or airfoils. For example, the first turbine assembly 208a may have a larger number of blades than the second turbine assembly 208b. In addition, the flow paths of the wind 404 through the turbine assemblies 208 and the movement of the turbine assemblies 208 in a direction that is generally away from the incident wind 404 can provide a safer environment for birds and other wildlife.

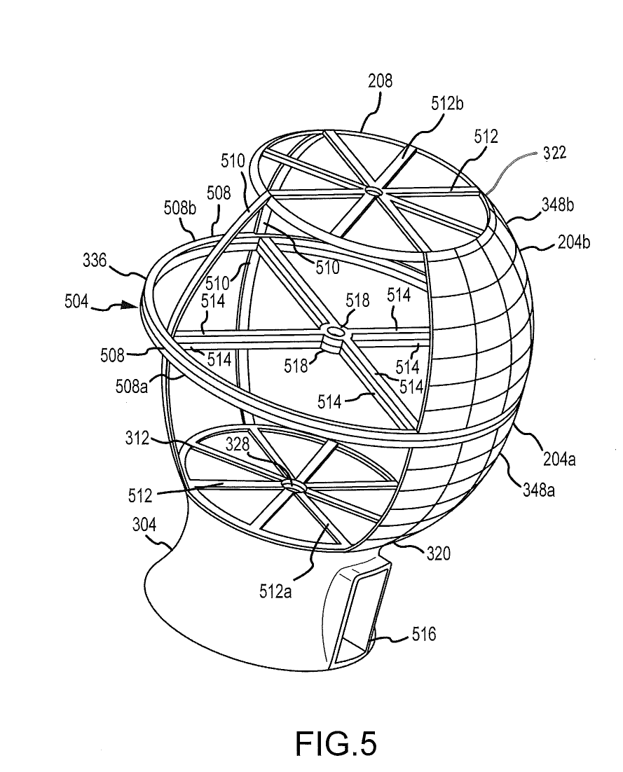

FIG. 5 is a perspective view of components of a support structure 504 of a wind turbine system in accordance with embodiments of the present invention. In addition, FIG. 5 illustrates the generally spherical volume or truncated spherical volume defined by the shroud assemblies 204. The support structure 504 can include the base member 304, the first shroud assembly 204a, and the second shroud assembly 204b. Additional details of embodiments of the shroud assemblies 204 are also illustrated. In particular, it can be seen that each shroud assembly 204 includes an equatorial support member 508. Moreover, the equatorial support member 508a of the first shroud assembly 204a is interconnected to the equatorial support member 508b of the second shroud assembly 204b by the equatorial bearing assembly 336. As discussed elsewhere herein, the equatorial bearing assembly 336 allows the rotational position of the second shroud assembly 204b to be changed relative to the first shroud assembly 204a and the base member 304. In accordance with further embodiments of the present invention, each shroud assembly 204 can include a number of longitudinal support members 510. For example, each shroud assembly 204 can include four longitudinal support members 510 spaced at 90° intervals. Moreover, each shroud assembly 204 can include radial members 514 that extend between the equatorial support member 508 and a center ring 518 of the associated shroud assembly 204. It can also be seen that, at least in some embodiments of the disclosed invention, the support for the second shroud assembly 204b can be entirely or primarily provided by the first shroud assembly 204a.

In addition to an equatorial support member 508 and longitudinal support members 510, each shroud assembly 204 can include a web structure 512. In general, the web structure 512 provides support for a corresponding shroud assembly 204, at an end of that shroud assembly 204 opposite the equatorial support member 508, and also provides support for longitudinal support members 510 that extend between the web structure 512 and the equatorial support member 508. The web structure 512a associated with the first shroud assembly 204a can also include or can be proximate to a portion of the peripheral bearing assembly 320 associated with the first shroud assembly 204a, and/or the central bearing assembly 328. The web structure 512b associated with the second shroud assembly 204b can function to provide additional support for the second shroud member 348b. In addition, the second web structure 512b can include or be associated with a portion of the bearing assembly 340. FIG. 5 also illustrates an access panel 516 in the base member 304. The access panel 516 can be used to access the generator 212 and/or other wind turbine system 104 components housed within the base member 304. In accordance with other embodiments of the present invention, the shroud members 348 can be rotated around the central axis 324 relative to the associated shroud assembly 204 support members and structures. For example, each shroud member 348 can be mounted to the remainder of the wind turbine system 104 by the equatorial bearing assembly 336 and by associated peripheral or end bearings 320 or 322 interconnected to the web structure 512 of the associated shroud assembly 204.

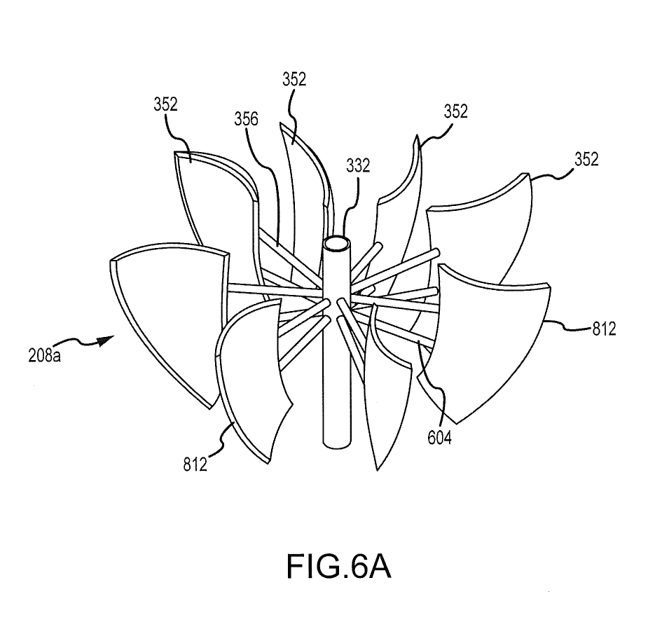

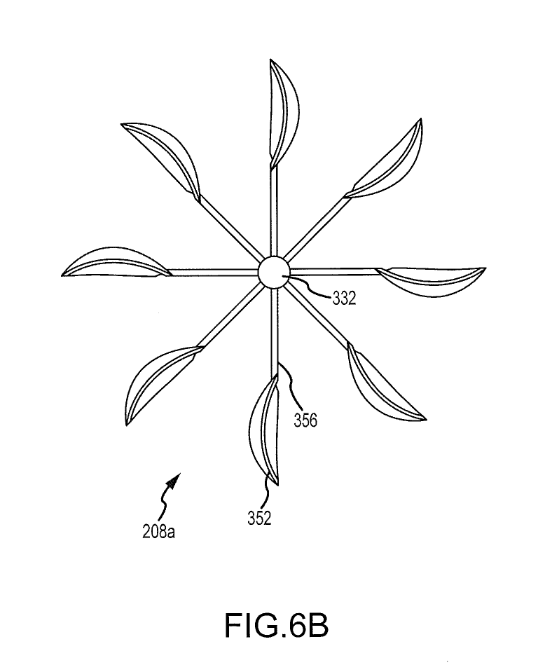

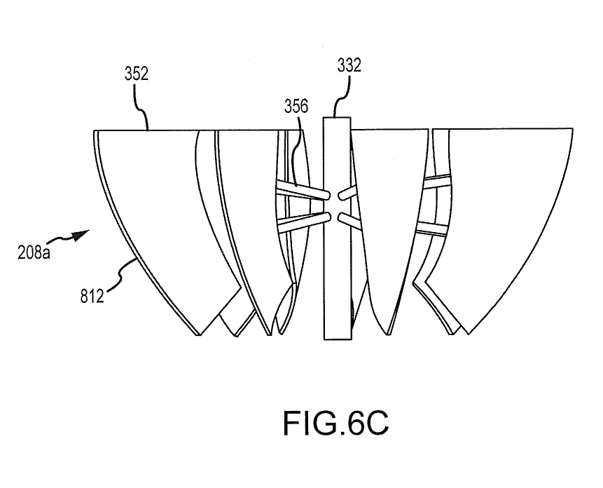

FIGS. 6A-6C illustrate top perspective, top plan, and elevation views respectively of a first turbine assembly 208a in accordance with embodiments of the present invention. As previously noted, the first turbine assembly 208a includes a plurality of airfoils or blades 352. In this example, eight blades 352 are shown. However, this is not a requirement, and the number of blades 352 in a particular embodiment will depend on the design of the individual airfoils 352 and other considerations. For instance, it is desirable to maintain a spacing between blades 352 that is sufficient to allow the individual blades 352 to operate efficiently. In particular, a blade 352 can function as a lifting body through at least some portion of the rotation of the turbine assembly 208. For example, with an associated shroud assembly 204 positioned so that the turbine assembly 208 can extract a maximum amount of energy from the wind, a blade 352 will act as a lifting body as it comes from behind the shroud member 348 and enters the air flow or wind, and for some additional degrees of rotation of the turbine assembly 208. Therefore, it is desirable to maintain a spacing between blades 352 that is large enough to allow each blade 352 to generate lift without being negatively impacted by turbulence from adjacent blades 352. Moreover, the blades 352 can be spaced such that as the angle of attack of a blade 352 increases and the blade 352 begins to spill wind, that spilled wind is directed towards and impacts a downwind blade 352. In addition, once the blade 352 has advanced to a point that the blade 352 is more normal to the wind, it is beneficial to maintain spacing between the blades 352 that is large enough to allow the wind to impact the blade 352 unimpeded or relatively unimpeded by the next blade 352. As can be appreciated by one of skill in the art, in selecting the number of blades 352 to include in a turbine assembly 208, the benefits of maintaining space between blades 352 is generally balanced against the additional force that can be extracted from wind of a given velocity by having a larger number of blades 352 exposed to the wind at a particular moment in time.

Each blade 352 in the illustrated example is interconnected to the first drive shaft 332 by a support structure 356 comprising a plurality of support struts 604. From the views in FIGS. 6A-6C, it can be appreciated that the blades 352 are shaped to be effective to rotate the first drive shaft 335 when a portion of the wind turbine assembly 208 is exposed to an incident wind with a component that is generally tangential to an outer circumference of the turbine assembly 208a. In particular, the blades 352 of the first wind turbine assembly 208a are configured to rotate the first drive shaft 335 in a clockwise direction, when the first wind turbine assembly 204a is viewed from above, and when exposed to such an incident wind. In addition, the blades 352 can be configured to direct at least some wind incident on the blades 352 in an end to end (e.g., a bottom to top) direction. Moreover, the outer edges 812 can be contoured so that the overall profile of the blade portion of the first turbine assembly 208a is hemispherical or hemispherical-like.

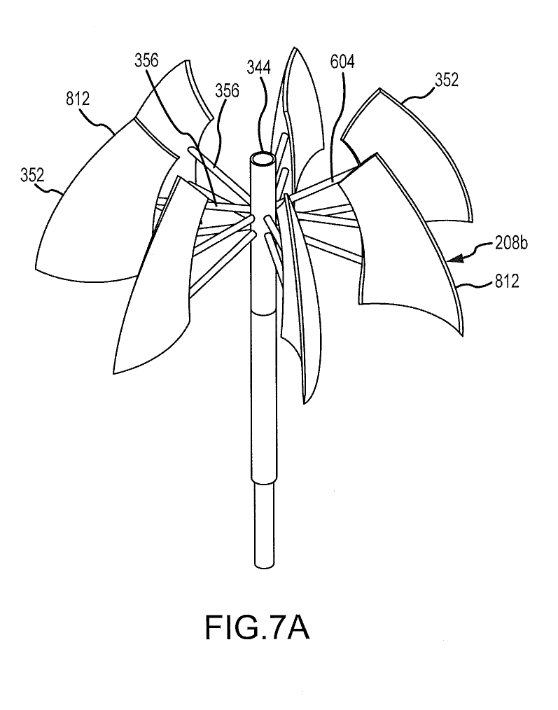

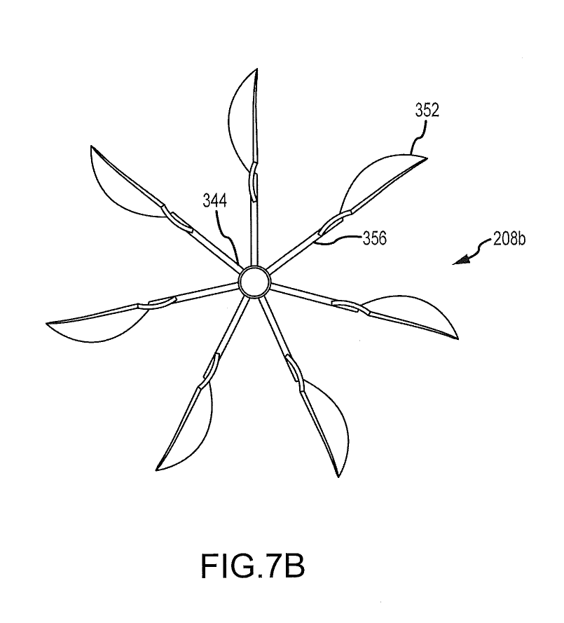

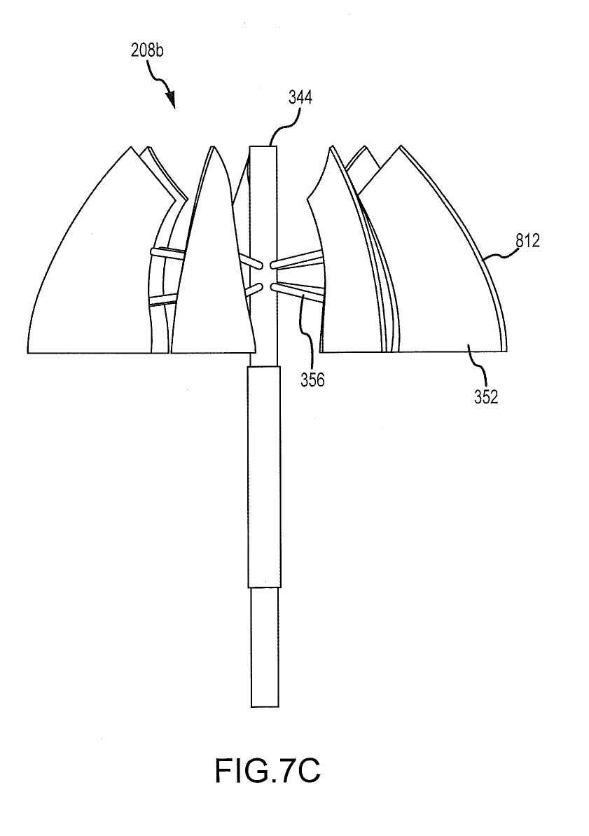

FIGS. 7A-7C illustrate a second turbine assembly 208b in accordance with embodiments of the present invention in top perspective, top plan and elevation views respectively. Similar to the first turbine assembly 208a, the second turbine assembly 208b includes a plurality of airfoils or blades 352. The blades 352 of the second turbine assembly 208b are interconnected to the second drive shaft 344 by a support structure 356. In the illustrated example, the support structure 356 includes a plurality of support struts 604 associated with each blade 352. In this embodiment, the blades 352 are configured to rotate the second drive shaft 344 in a counterclockwise direction when the second turbine assembly 208b is viewed from above, in the presence of an incident wind having a component that is generally tangential to an outer circumference of the turbine assembly 208a. In addition, it can be appreciated that the blades 352 are configured to impart a rotational force to the second drive shaft 344 in a counterclockwise direction in response to an updraft of wind (or a bottom to top flow generally parallel to the system axis 324), such as may be provided by a first turbine assembly 208a in a wind turbine system 104 configured as illustrated in, for example, FIGS. 3 and 4. It can also be appreciated that at least a portion of the wind incident on the second turbine assembly 208b, either tangentially or as an updraft, can be exhausted in an upward direction (or in a direction generally parallel to the system axis 324). The outer edges 812 of the blades 352 can be contoured so that the overall profile of the blade portion of the second turbine assembly 208b is hemispherical or hemispherical-like.

In the example first turbine assembly 208a of FIGS. 6A-6C, seven blades 352 are shown, while in the example second turbine assembly 208b of FIGS. 7A-7C, six blades 352 are shown. The number of blades 352 in the turbine assemblies 208 of a particular embodiment of a wind turbine system 104 in accordance with the present invention will vary depending on the particular application and design considerations for example as described above in connection with the first turbine assembly 208a. In accordance with at least some embodiments of the present invention, the first 208a and second 208b turbine assemblies each have a different number of blades 352. In accordance with still further embodiments, the first turbine assembly 208a has a larger number of blades 352 than the second turbine assembly 208b. By so configuring the wind turbine system 104, vibration and noise produced during operation of the wind turbine system 104 can be reduced as compared to embodiments in which the first 208a and second 208b turbine assemblies have the same number of blades 352.

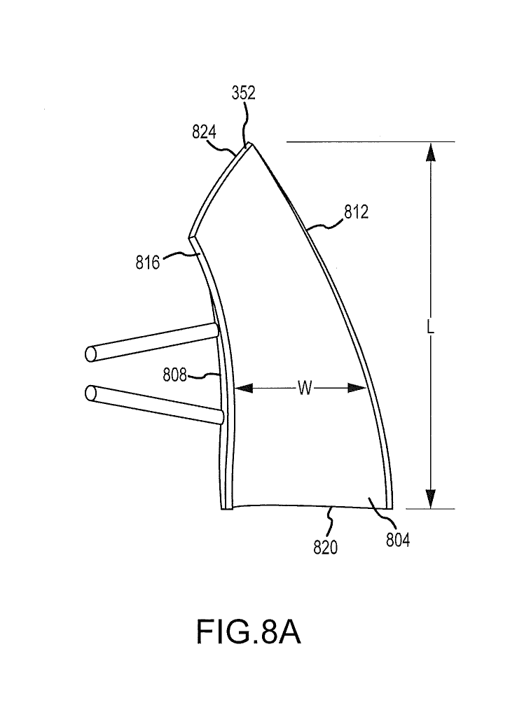

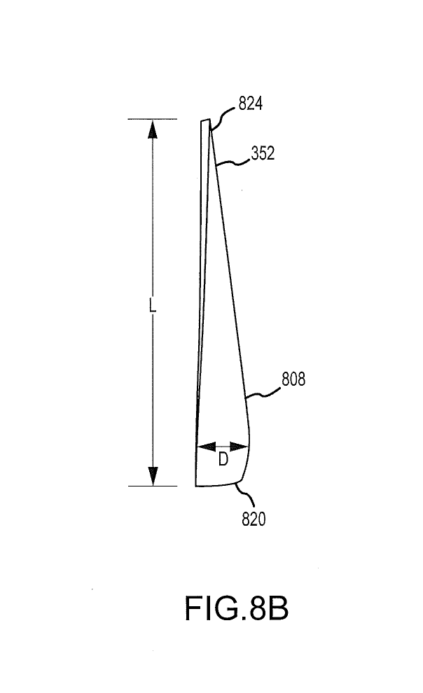

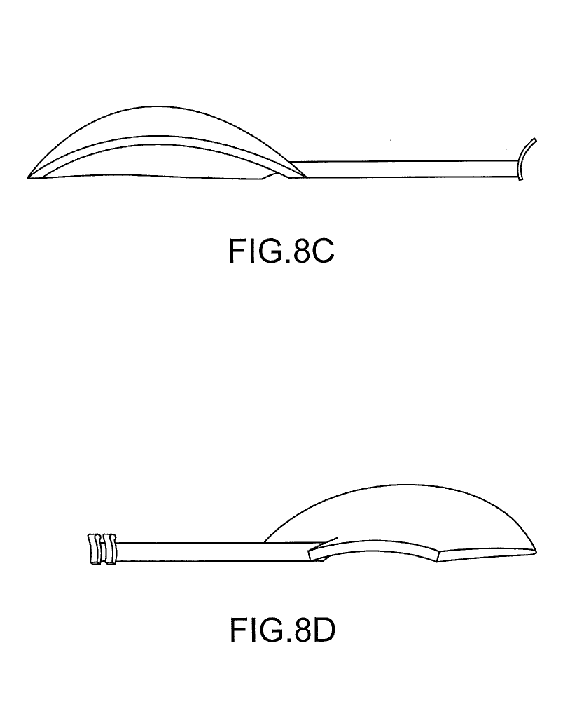

FIGS. 8A-8D provide different views of a blade 352 of a turbine assembly 204 in accordance with embodiments of the present invention. In particular, FIG. 8A is a perspective view, FIG. 8B is a side elevation, FIG. 8C is a first plan view, and FIG. 8D is a second plan view of an exemplary blade 352 in accordance with embodiments of the present invention. The blade 352 includes a first surface 804 that is cupped or profiled to capture wind incident on that surface 804. In addition or as an alternative to trapping wind like a bucket, the blades 352 can comprise lifting bodies. Therefore, a wind turbine system 104 can comprise both impulse turbine and reaction turbine operating principles. In operation, a wind system 104 in accordance with embodiments of the present invention generally positions the shroud members 348 such that the wind is allowed to be incident on the first surface 804 of the turbine assembly 208 blades 352. In addition, each blade 352 has a second surface 808 that is relatively streamlined such that, to the extent the blade 352 travels in a direction away from the first side 804 and towards the second side 808 of the blade 352, any air in front of the blade 352 during such movement is easily displaced. Accordingly, the blades 352 may be profiled such that the turbine assembly 208 including such blades 352 is rotated in one particular direction in the presence of a wind with a component that is tangential to the outer circumference of the turbine assembly 208.

In addition, the shape and/or contour of a blade 352 can be compound complex geometry and/or asymmetric geometry. For instance, the width W of the blade 352 can be different at different points along the length L of the blade 352. In addition, an outer side edge or leading edge 812 of the blade 352 can be curved, to define the generally hemispherical shape of a turbine assembly 208 including the blade 352. The blade 352 also includes an inner side edge or trailing edge 816 that, together with the outer side edge 812, defines the width of the blade 352. For example, and as shown in FIG. 8A, the side edges 812 and 816 can define a blade 352 with a width W that generally decreases from a base edge or end 820 of the blade 352 to the tapered or narrowed edge or end 824 of the blade 352. Moreover, the first surface 804 may curve from the base edge 820 to the tapered edge 824. For example, the curve may be generally inwardly from the base edge 820 to the tapered edge 824.

In addition to various curves and changes in dimension along the length L of the blade 352 when considered in a front view (see generally FIG. 8A), the blade 352 can also vary in the depth D of the cup or concave surface (or alternatively the height of the concave back surface 808). This depth D may vary with position along the length L of the blade 352. For example, moving from the base edge 820, the depth D can increase as the distance from the base edge 820 along the length L increases. After reaching a maximum point proximate the base edge 820, the depth D may gradually decrease as the distance from the base edge 820 along the length L decreases, until a minimum depth D proximate the tapered edge 824 is reached.

After consideration of FIGS. 8A-8D, it can be appreciated that the blade 352 may be contoured so as to provide a lifting body or airfoil. Therefore, wind flowing across the blade 352 will produce lift, at least within some range of angles of attack. Accordingly, the blades 352 may comprise airfoils or lifting bodies. Moreover, lift generated by the blades 352 of a turbine assembly 208 will result in a force in a direction that tends to rotate the associated turbine assembly 208. In addition, wind incident on the first surface 804 of a blade 352 is generally captured by the blade 352, to promote a transfer of energy from that wind to, for example, a turbine assembly 208 that includes the blade 352. Moreover, the blade 352 generally moves in a direction away from the wind. As a result, turbine assemblies 208 incorporating the blades 352 can comprise a combination of impulse turbine and reaction turbine operating characteristics.

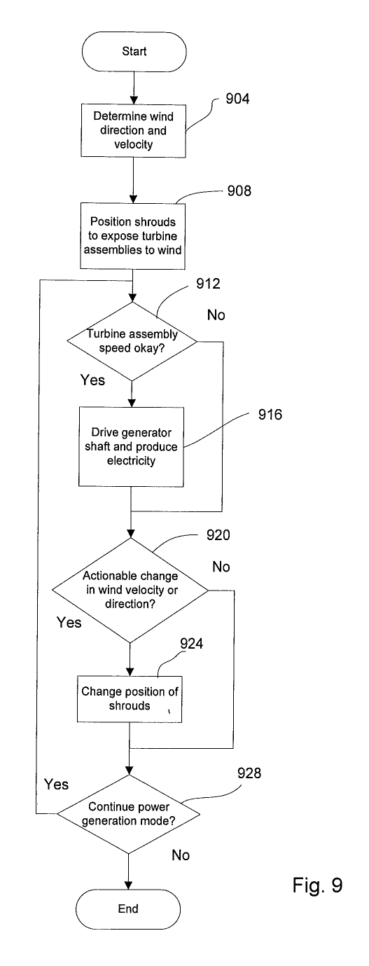

FIG. 9 is a flowchart depicting aspects of the operation of a wind turbine system 104 in accordance with embodiments of the present invention, and in particular operation while the wind turbine system 104 is in a power generation mode. As can be appreciated by one of skill in the art after consideration of the present disclosure, the operation of the wind turbine system 104 can be controlled by the wind turbine control system 220 and in particular the execution of control algorithms 244 by the wind turbine control system 220. Initially, after entering the power generation mode, the wind direction and velocity is determined (step 904). The wind direction and velocity can be provided by the wind sensor 224 to the wind turbine control system 220. The shroud members 348 are then positioned to expose the turbine assemblies 208 to the wind (step 908). More particularly, the first shroud assembly 204a and/or the first shroud member 348a can be positioned such that a first quadrant or other portion of a first turbine assembly 208 is uncovered, such that the wind is incident on the first surface 804 of the blades 352 within that quadrant. Similarly, the second shroud assembly 204b and/or the second shroud member 348b can be positioned such that the associated shroud member 348b allows the wind to be incident on a first surface 804 of some of the blades 352 of the second turbine assembly 208b within a quadrant of the second turbine assembly. By thus exposing some of the blades 352 of the turbine assemblies 208 to the wind, those turbine assemblies 208 will begin to rotate relative to the central axis 324 of the wind turbine assembly 104. In accordance with embodiments of the present invention, the wind turbine control system 220 operates the shroud control motors 248 to position the shroud members 348 at the desired orientation with respect to the wind.

A determination may then be made as to whether the rotational speed of the turbine assemblies 208 is within power generation parameters (step 912). If the rotational speed of the turbine assemblies 208 is within the power generation parameters, a clutch 218 included in the drive train assembly 216 can be engaged, to connect the first 332 and second 344 drive shafts carrying the first 208a and second 208b turbine assemblies respectively to a drive or input shaft of the generator 212 to produce electricity (step 916). As can be appreciated by one of skill in the art after consideration of the present disclosure, a turbine assembly 208 rotational speed that is either too slow or too fast may be unsuitable for use in power generation. Therefore, if the turbine assembly 208 rotational speed is not within the power generation parameters of the wind turbine system 104, the wind turbine assemblies 208 may remain disconnected from the generator 212. Exemplary operating speeds, in revolutions per minute (RPM), range from 0 to 6,500 RPM. As another example, the wind turbine assemblies 208 may be selectively interconnected to the generator 212 in response to the velocity of the incident wind. For example, the turbine assemblies 208 may be operatively interconnected to the generator 212 when the incident wind speed is between about 4 miles per hour and about 90 miles per hour. As can be appreciated by one of skill in the art after consideration of the present disclosure, the rotating speed of the turbine assemblies 208 can be provided to the wind turbine control system 220 by the tachometer 228.

After operatively interconnecting the turbine assemblies 208 to the generator 212 at step 916, or after determining at step 912 that the turbine assembly 208 rotational speed is not within operational parameters, a determination may be made as to whether an actionable change in either the wind velocity or the wind direction has been observed (step 920). If an actionable change in wind velocity or direction has been observed, the position of the shroud members 348 can be changed (step 924). For instance, if the direction of the wind has changed by at least some minimum number of degrees, the shroud assemblies 204 can be rotated about the system axis 324 in the same direction such that the exposure of the first 208a and second 208b turbine assemblies to the wind remains equal or substantially equal. As an example, and without limitation, an actionable change can occur when the wind direction is more than 5° to either side of being equally incident on the shroud members 358. In response to a change in wind velocity, the shroud assemblies 204a and 204b and/or the shroud members 348 can be rotated in opposite directions about the system axis 324 to change the area of each turbine assembly 208a and 208b that is exposed to the wind. Moreover, the rotational position of the shroud assemblies 204 can be changed in response to a combination of a change in the direction and a change in the velocity of the wind.

At step 928, a determination may be made as to whether the power generation mode is to be continued. If power generation is to be continued, the process may return to step 912. If the power generation mode is to be discontinued, the process may end.

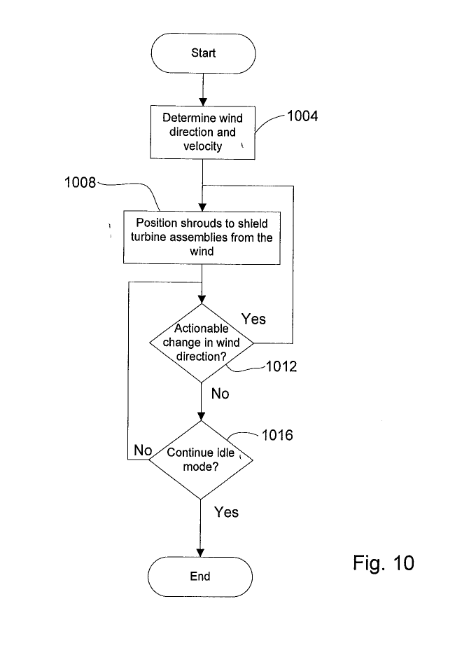

With reference now to FIG. 10, aspects of the operation of a wind turbine system 104 in accordance with embodiments of the present invention while in an idle mode are illustrated. The operation of the wind turbine system 104 while in an idle mode can be controlled by the wind turbine control system 220. Initially, at step 1004, the wind direction and velocity is determined. The wind direction and velocity information can be supplied to the wind turbine control system 220 by the wind sensor 224. The shroud assemblies 204 are then positioned to shield the turbine assemblies 208 from the wind (step 1008). In particular, the shroud assemblies 204 and/or the shroud members 348 are positioned to place the respective shroud members 348 in a position to shield all or substantially all of the blades 352 of the turbine assemblies 208 from the wind. At step 1012, a determination is made as to whether an actionable change in wind direction has occurred. For example, if the wind direction has shifted by some minimum number of degrees, the change can be considered actionable. As an example, and without limitation, an actionable change can occur when the wind direction is more than 5° to either side of being equally incident or centered on the shroud members 358. In response to an actionable change in wind direction, the process may return to step 1008, and the position of the shroud assemblies 204 is altered in response to the changed wind direction. If an actionable change in the wind direction has not occurred, a determination may be made as to whether the idle mode should be continued (step 1016). If the idle mode is to be continued, the process may return to step 1012. If the idle mode is to be discontinued, the process may end.

In accordance with embodiments of the present invention, power to operate the wind turbine control system 220, the wind sensor 224, the shroud control motors 248, and/or other electrically powered components of the wind turbine system 104 while the system is in an idle mode, or while it is in a power generation mode under conditions where the generated power is too low or is entirely routed to the grid, can be supplied from various sources. For example, the wind turbine system 104 can include or be interconnected to batteries, solar cells, fuel cells, or the like. Alternatively or in addition, power can be drawn from the electrical distribution grid. Moreover, as can be appreciated by one of skill in the art after consideration of the present description, in the power generation mode, the wind turbine system 104 can supply power produced by the electrical generator 212 to the power distribution grid, and/or to local (e.g., building) power subsystems.

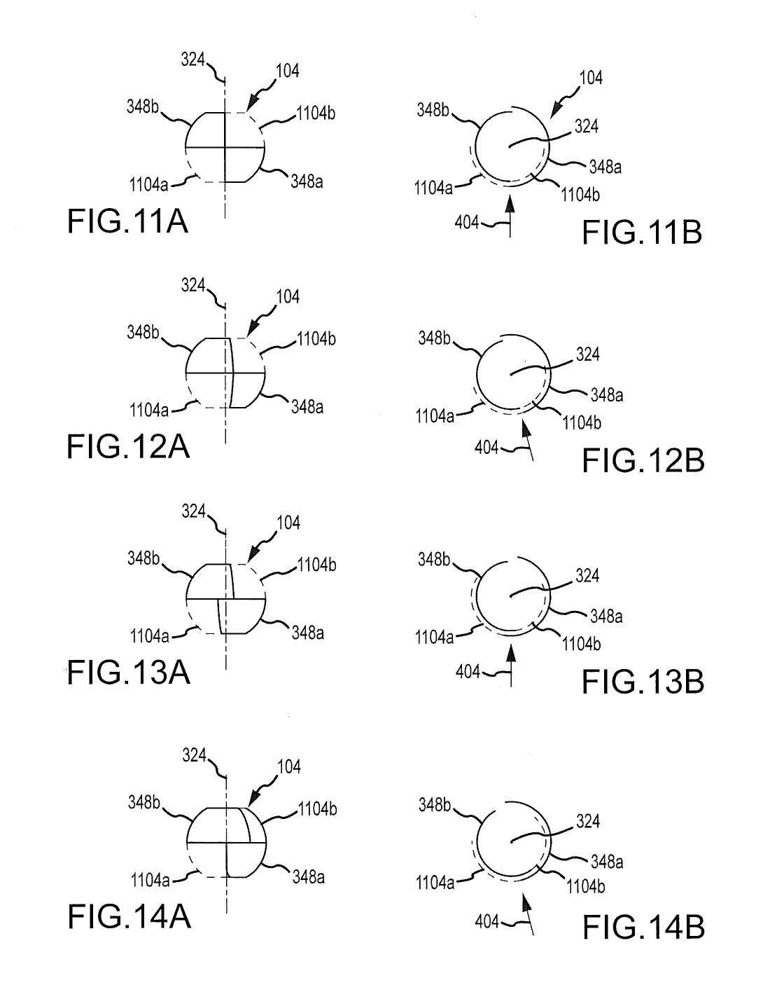

FIGS. 11A-11B illustrate shroud member 348 positions relative to the wind 404, while the wind turbine system 104 is in a power generation mode, and while the wind 404 is incident on the wind turbine system 104 from a first direction. More particularly FIG. 11A is a view in elevation of a wind turbine system 104 in a power generation mode, with the wind traveling in a direction that is directly into the page. The configuration of the shrouds 348 illustrated in FIG. 11A is depicted in a top plan view in FIG. 11B. In this configuration, the wind turbine system 104 can draw a maximum amount of available energy from the incident wind 404. In particular, one quadrant or about 90° of a first area 1104a in a first hemisphere of the wind turbine system 104 is uncovered, thus exposing the first turbine assembly 208a (see, e.g., FIG. 2) to the wind 404. Similarly, a second area 1104b in a second hemisphere of the wind turbine system 104 is unshielded by the second shroud 348b, exposing a portion of the second turbine assembly 208b (see, e.g., FIG. 2) to the incident wind 404. As can be appreciated by one of skill in the art after consideration of the disclosure provided herein, by thus exposing the turbine assemblies 208 to the incident wind 404, at least a first component of that incident wind 404 is tangential to the first turbine assembly 208a, and at least a second component of the incident wind 404 is tangential to the second turbine assembly 208b. Moreover, by exposing the turbine assemblies 208 to the wind at opposed quadrants of the wind turbine system 104, the turbine assemblies 208 will tend to rotate in opposite directions. Moreover, the configuration exposes a first side 804 of the turbine assembly blades 352 to the incident wind 404, while shielding the second side 808 of the blades 352, promoting the efficient rotation of the turbine assemblies 208.

In FIGS. 12A and 12B, a wind turbine system 104 in a maximum power generation mode is again illustrated in elevation (FIG. 12A) and top plan (FIG. 12B) views. However, in these views, the direction of the incident wind 404 has shifted by about 15° as compared to the conditions depicted in FIGS. 11A and 11B. In response to this shift in the direction of the wind 404, the rotational position of the shroud members 348 has changed. In particular, the shrouds 348 have been rotated about the system axis 324, to maintain an exposure to the turbine assemblies 208 that maximizes the energy transferred from the incident wind 404 to the wind turbine system 104. Therefore, while the same or about the same area 1104a and 1104b is exposed to the incident wind 404 (i.e., the areas 1104a and 1104b are the same as the example in FIGS. 11A and 11B when considered from a view taken along the wind direction), the absolute orientation of the shroud members 348 relative to the central axis 324 is shifted to track the change in wind 404 direction.

FIGS. 13A and 13B depict an exemplary shroud member 348 configuration while the wind turbine system 104 is in a power generation mode, in the presence of a relatively strong incident wind 404. With respect to FIG. 13A, the wind is traveling in a direction that is directly into the page. In this configuration, the areas 1104a and 1104b of exposure of the turbine assemblies 204 has been reduced. That is, more of the area of the wind turbine assemblies 204 is shielded by the shroud members 348. Accordingly, the amount of wind 404 incident on the turbine assemblies 204 is reduced, thereby reducing the amount of energy transferred from the wind 404 by the wind turbine system 104 as compared to a configuration in which the exposed areas 1104a and 1104b are larger. The exposed area 1104a and 1104b can be further decreased if the velocity of the incident wind 404 increases. Similarly, in response to a decrease in the incident wind speed 404, the exposed areas 1104a and 1104b can be increased, until the velocity of the incident wind 404 has decreased to below some threshold amount, at which point the maximum power configuration depicted in FIGS. 11A, 11B, 12A and 12B is reached. Accordingly, the wind turbine system 104 can be selectively depowered.

While operating in the power generation mode in the presence of strong incident wind, in addition to reducing the exposed areas 1104a and 1104b, the rotational positions of the shroud members 348 can be altered to track changes in the direction of the incident wind 404. An example of a change in the position of the shroud members 348 due to a change in direction of a strong incident wind 404, as compared to the direction of the strong incident wind depicted in FIGS. 13A and 13B, is depicted in FIGS. 14A and 14B. In particular, while the areas 1104a and 1104b of exposed turbine assembly 208 remains depowered, the orientation of those areas has been shifted to track the change in the direction of the wind 404.

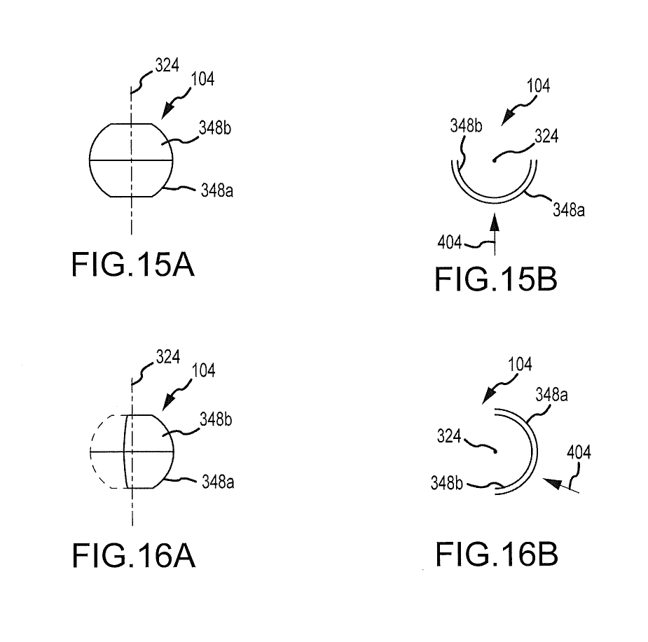

FIGS. 15A and 15B illustrate shroud member 348 positions relative to the wind 404 while the wind turbine system 104 is in an idle mode. More particularly, FIG. 15A is a view in elevation of a wind turbine system 104 in an idle mode, with the wind traveling in a direction that is directly into the page. The configuration of the shrouds 348 illustrated in FIG. 15A is depicted in top plan view in FIG. 15B. In this configuration, the turbine assemblies 208 are completely or substantially shielded from the incident wind 404. This idle mode is generally entered when power generation is not desired or when the incident wind 404 velocity is too high for safe and reliable operation of the wind turbine system 104.

FIGS. 16A and 16B illustrate the shroud member 348 positions in the idle mode, but in the presence of a wind shift of about 75° as compared to the wind direction and the configuration illustrated in FIGS. 15A and 15B. In particular, in order to track the shift in wind 404 direction, the shroud assemblies 204 are positioned to place the respective shroud members 308 such that the turbine assemblies 208 remain shielded from the wind 404. Therefore, it can be appreciated that, even in an idle mode, the position of the shroud members 348 about the system axis 324 can continue to be varied with changes in wind 404 direction.

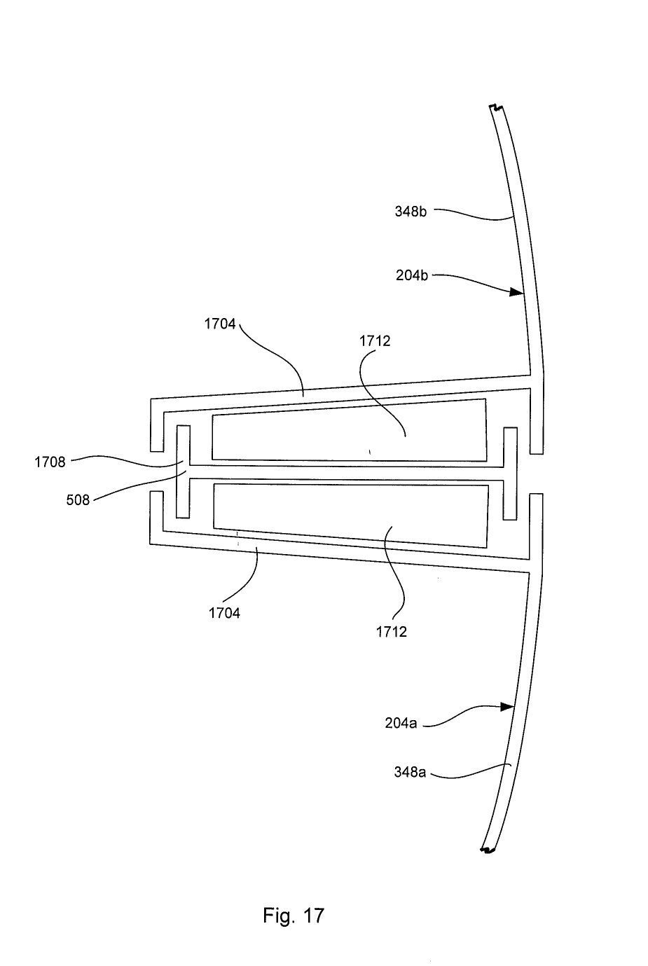

FIG. 17 depicts features of an equatorial bearing assembly 336 in accordance with embodiments of the present invention. In particular, a portion of an equatorial bearing assembly 336 is depicted in cross-section. As shown in the figure, the first and second shroud assemblies 204 are each associated with a bearing race 1704. Each shroud assembly bearing race 1704 cooperates with an equatorial ring bearing race 1708 and tapered roller bearings 1712 to support an associated shroud assembly 204 and/or shroud member 348 at the equatorial support member 508. As can be appreciated by one of skill in the art after consideration of the present disclosure, a tapered roller bearing type assembly provides excellent load bearing capacity and lateral support.

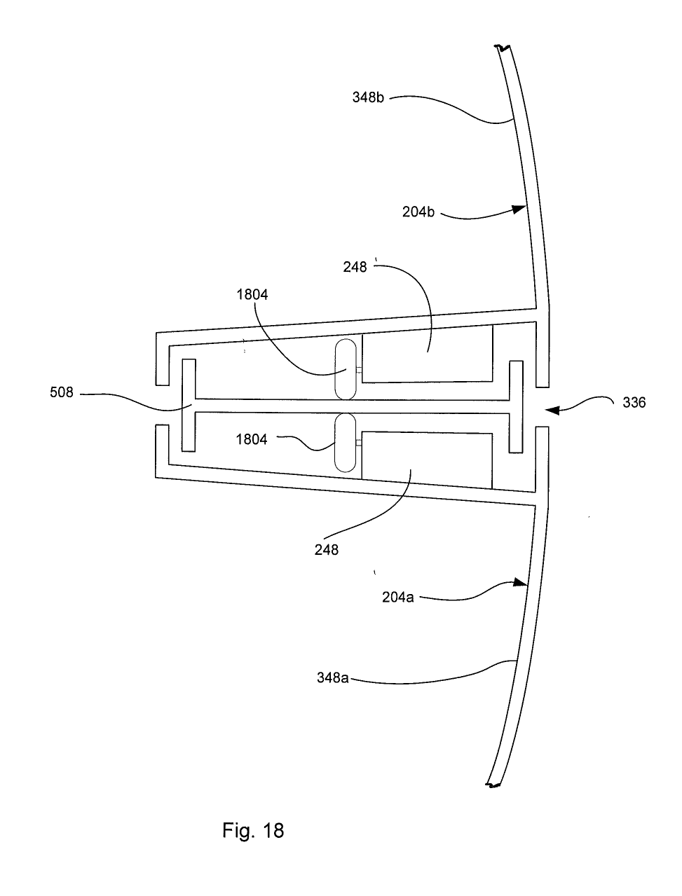

FIG. 18 depicts another portion of the equatorial bearing assembly 336 in accordance with embodiments of the present invention. For example, the cross-section depicted in FIG. 18 is at a different radial location about the wind turbine assembly 104 than the cross-section depicted in FIG. 17. At the radial location depicted in FIG. 18, shroud control motors 248 are shown. Each shroud control motor 248 is associated with a drive wheel 1804. Moreover, in the illustrated embodiment, each drive motor 248 is fixed to an associated shroud assembly 204, and each drive wheel 1804 is in contact with the bearing race 1708. Accordingly, by activating the shroud control motors 248, an interconnected shroud member 348 can be rotated about the central axis 324 (not shown in FIG. 18) of the wind turbine system 104. Although a first stepper motor 248a associated with a first shroud assembly 204a and a second stepper motor 248b associated with the second shroud assembly 204b are shown at the same radial location, stepper motors 248 can be at different radial locations, depending on the operating mode and operating conditions.

In accordance with embodiments of the present invention, multiple shroud control motors 248 are associated with each shroud assembly 204. As an example, and without limitation, each shroud assembly 204 may be associated with four shroud control motors 248. In accordance with further embodiments of the present invention, each shroud control motor 248 may comprise a stepper motor. Moreover, the set of shroud control motors 248 associated with any one shroud assembly 204 may be synchronized to one another. Accordingly, the wind turbine control system 220 can rotate a selected shroud member 348 a selected number of degrees by providing a control signal to turn the shroud control motors 248 associated with the selected shroud member 348 a selected number of steps. Moreover, by tracking the number of steps and the direction that the shroud control motors 248 are turned, the wind turbine control system 220 can maintain a record of the relative rotational position of each shroud 348.

As disclosed herein, a wind turbine system 104 in accordance with embodiments of the present invention includes counter-rotating turbine assemblies 208. In at least some embodiments, a first turbine assembly 208a includes a plurality of airfoils or blades that spin in a direction that is opposite the direction of spin of the second turbine assembly 208b, thus substantially canceling out the inertia or twisting motion that would otherwise be induced by the force of turning the turbine assemblies 208 in only one direction. In addition, the geometry of the first turbine assembly 208a blades 352 forces the incident wind 404 to not only turn the turbine assembly 204a, but in addition to direct excess wind load upward into the second turbine assembly 208b, thus acting similar to a two stage compressor and providing additional kinetic energy to move the second turbine assembly 208b. In addition, the blades 352 of the first turbine assembly 208a can be the mirror image of the blades 352 of the second turbine assembly 308b and can comprise lifting bodies. The number of blades included in the first turbine assembly 208a is generally different than the number of blades 352 included in the second turbine assembly 208b. As examples, from 5 to 13 blades 352 can be included any one turbine assembly 208.

The blades 352 may be made from a variety of different materials such as but not limited to metals, composites, plastics, combinations thereof, and the like. For example, the materials can include an ALUCOBOND™ composite material (an aluminum composite material that includes two sheets of aluminum thermo bonded to a polyethylene core), carbon composites, aluminum, galvanized metals, plastics or similar lightweight materials. The blades 352 may incorporate any of a number of different geometries and may comprise turbine blades, lifting bodies, airfoils, sails, and the like. In an exemplary configuration, the blades 352 can comprise a cambered surface that extends from about 10% to about 20% or higher from the side edges 812 and 816 of the blade 352. As a particular example, the cambered surface can extend about 12%. In addition, an airfoil 352 can incorporate a curve when considered in a front elevation view.

The shroud members 358 can comprise hemispherical aero shells. The shroud assemblies 204 incorporating the shroud members 358 can be formed from various materials. Suitable materials include ALCUBOND™ composite material, carbon composites, sheet metal, sheet screens, aluminum, plastics, or the like.

Exemplary generators 212 include three phase induction generators at various outputs, depending on the size and intended use of the wind turbine system 104. Exemplary power outputs include 60 KW, 120 KW, 200 KW, 500 KW and 700 KW production capacities. As can be appreciated by one of skill in the art after consideration of the present disclosure, a generator 212 can provide output power to an inverter system, for distribution of electricity into an electrical power bus or transformers of the user and the public utility grid. Accordingly, 60 Hz alternating current power can be provided by the wind turbine system 104, for use at the location of the wind turbine system 104, and/or for distribution by the public utility grid.

In an exemplary configuration, the turbine assemblies 208 have a radius from about 3 feet for a relatively small system to about 20 feet for a relatively large (e.g., 500 KW) system. The height of the overall wind turbine system 104 can range from about 14 feet for a small (e.g., 60 KW) system to about 50 feet for a large system. In one exemplary embodiment, an individual blade 352 has a total area of greater than 54 square feet, as determined by Euler's formula as known one of ordinary skill in the art, for converting wind power into work power based on surface area presented to the wind stream.

The operating revolutions per minute (RPM) of the turbine assemblies 208 can range from about 0 RPM to about 5,000 RPM and greater. For example, a wind turbine system 104 in accordance with embodiments of the present invention can be controlled to maintain rotation of the turbine assemblies 208 between about 3,000 RPM to about 6,500 RPM.

The foregoing discussion of the invention has been presented for purposes of illustration and description. Further, the description is not intended to limit the invention to the form disclosed herein. Consequently, variations and modifications commensurate with the above teachings, within the skill or knowledge of the relevant art, are within the scope of the present invention. The embodiments described hereinabove are further intended to explain the best mode presently known of practicing the invention and to enable others skilled in the art to utilize the invention in such or in other embodiments and with various modifications required by the particular application or use of the invention. It is intended that the appended claims be construed to include alternative embodiments to the extent permitted by the prior art.

What is claimed is:

1. A method for controlling a wind turbine, comprising:
determining a direction of an incident wind;
in response to determining the direction of the incident wind:
controlling an attitude of a first shroud with respect to the incident wind;
controlling an attitude of a second shroud with respect to the incident wind.

2. The method of claim 1, further comprising:
determining an operating mode of the wind turbine;
in response to determining that the wind turbine is in a power generation mode:
controlling the attitude of the first shroud with respect to the wind to expose at least a portion of a quadrant of a first turbine assembly to the incident wind;
controlling the attitude of the second shroud with respect to the wind to expose at least a portion of a quadrant of a second turbine assembly to the incident wind.

3. The method of claim 2, wherein the at least a portion of a quadrant of the first turbine assembly that is exposed to the wind is on a first side of a plane parallel to a rotating axis of the turbine assemblies and parallel to the determined wind direction, and wherein the at least a portion of a quadrant of the second turbine assembly that is exposed to the wind is on a second side of the plane parallel to the rotating axis of the turbine assemblies and parallel to the determined wind direction.

4. The method of claim 3, wherein the portion of a quadrant of the first turbine assembly that is exposed to the wind is equal to a first area, and wherein the portion of a quadrant of the second turbine assembly that is exposed to the wind is equal to the first area.

5. The method of claim 3, further comprising:
detecting a change in the direction of the incident wind;
in response to detecting a change in the direction of the incident wind, rotating the first shroud in a first direction by a first amount, and rotating the second shroud in the first direction by the first amount.

6. The method of claim 2, further comprising:
detecting a change in the velocity of the incident wind;
in response to detecting a change in the velocity of the incident wind, rotating the first shroud in a first direction by a first amount, and rotating the second shroud in a second direction by the first amount.

7. The method of claim 2, further comprising:
detecting a change in the direction of the incident wind;
detecting a change in the velocity of the incident wind;
in response to detecting a change in the direction of the incident wind and in response to detecting a change in the velocity of the incident wind, rotating the first shroud in a first direction by a first amount, and rotating the second shroud in a second direction by a second amount.

8. The method of claim 2, further comprising:
detecting a change in a revolution per minute count of one of the first turbine assembly and the second turbine assembly;
in response to detecting a change in a revolution per minute count, rotating the first shroud in a first direction, and rotating the second shroud in a second direction.

9. The method of claim 1, further comprising:
determining an operating mode of the wind turbine assembly;
determining that the wind turbine assembly is in an idle mode;
after determining that the wind turbine assembly is in an idle mode, detecting a change in the direction of the incident wind;
in response to determining a change in the direction of the incident wind, rotating the first shroud in a first direction by a first amount, and rotating the second shroud in the first direction by the first amount.

10. The method of claim 9, further comprising:
after rotating the first shroud in a first direction by a first amount and rotating the second shroud in the first direction by the first amount, determining that an operating mode of the wind turbine assembly has changed from an idle mode to a power generation mode;
in response to determining that the wind turbine assembly is in power generation mode:
controlling the attitude of the first shroud with respect to the wind to expose at least a first portion of a quadrant of a first turbine assembly to the incident wind;
controlling the attitude of the second shroud with respect to the wind to expose at least a first portion of a quadrant of a second turbine assembly to the incident wind.

11. A wind turbine system, comprising:
a first shroud assembly, including:
a first shroud member;
at least a first shroud control motor;
a second shroud assembly, including:
a second shroud member;
at least a second shroud control motor;
a wind sensor, wherein the wind sensor is operative to output incident wind speed and direction information;
a processor, wherein the processor is interconnected to and is operative to receive incident wind speed and direction information from the wind sensor, wherein the processor is interconnected to the first and second shroud control motors and is operative in response to the wind speed and direction information to control operation of the at least a first shroud control motor to select an attitude of the first shroud member with respect to the incident wind and to control operation of the at least a second shroud control motor to select an attitude of the second shroud member with respect to the incident wind.

12. The system of claim 11, wherein the first shroud control motor includes a first set of one or more stepper motors, and wherein the second shroud control motor includes a second set of one or more stepper motors.

13. The system of claim 11, wherein the wind sensor includes a wind direction sensor and a wind velocity sensor.

14. The system of claim 11, wherein the wind sensor comprises an ultrasonic anemometer.

15. The system of claim 11, further comprising:
an equatorial bearing assembly;
a first web structure;
a second web structure, wherein the first shroud assembly includes a first hemispherical shroud that extends for about 180° between the equatorial bearing assembly and the first web structure, and wherein the second shroud assembly includes a second hemispherical shroud that extends for about 180° between the equatorial bearing assembly and the second web structure.

16. A method for controlling a wind turbine, comprising:
determining at least one of an incident wind direction and velocity;
in a first operating mode and in response to determining the at least one of an incident wind direction and velocity:
controlling a first shroud to selectively expose a first portion of a first turbine assembly to the incident wind, wherein controlling the first shroud includes controlling at least a first motor to place the first shroud in a selected rotational position with respect to a center axis of the wind turbine;
controlling a second shroud to selectively expose a first portion of a second turbine assembly to the incident wind, wherein controlling the second shroud includes controlling at least a second motor to place the second shroud in a selected rotational position with respect to the outer axis of the wind turbine, wherein the exposed first portion of the first turbine assembly is in a first quadrant of the wind turbine, and wherein the exposed first portion of the second turbine assembly is in a second quadrant of the wind turbine, wherein the first and second quadrants are diagonally opposite from one another.

17. The method of claim 16, wherein the incident wind is parallel to a substantially vertical plane, wherein the first quadrant is about a first number of degrees on a first side of the substantially vertical plane, and wherein the second quadrant is about the first number of degrees on a second side of the substantially vertical plane.

18. The method of claim 17, further comprising:
detecting a change in the direction of the incident wind of a first number of degrees;
in response to detecting a change in the direction of the incident wind of a first number of degrees, changing a rotational position of the first and second shrouds by the first number of degrees.

19. The method of claim 17, further comprising:
detecting a change in the velocity of the incident wind;
in response to detecting a change in the velocity of the incident wind,

20. The method of claim 16, the method further comprising:
in a second operating mode:
shielding the first turbine assembly from the wind with the first shroud;
shielding the second turbine assembly from the wind with the second shroud.
